(19) United States
(12) Patent Application Publication
(10) Pub. No.: US 2024/0209651 A1
(43) Pub. Date: Jun. 27, 2024

(54) WIND TURBINE TOWER AND METHOD OF FABRICATION AND ASSEMBLING

(71) Applicant: SOLETANCHE FREYSSINET, Rueil Malmaison (FR)

(72) Inventors: Jean-Daniel LEBON, Saint Germain Laye (FR); Eric LAURENT, Boissy Sous Saint Yon (FR)

(21) Appl. No.: 17/614,650

(22) PCT Filed: May 20, 2020
(86) PCT No.: PCT/EP2020/064114

§ 371 Date: Nov. 29, 2021

(30) Foreign Application Priority Data
May 27, 2019 (EP) 19305666.0

(51) Int. Cl. E04H 12/12; B28B 23/02; E04H 12/34; F03D 13/20; F03D 13/40

(52) U.S. Cl. CPC E04H 12/12; E04H 12/342; F03D 13/205; B28B 23/02; F03D 13/402; F05B 2230/20; F05B 2230/61; F05B 2260/02

(57) ABSTRACT

A wind turbine tower including a plurality of annular segments axially aligned with each other, at least one of the annular segments having a plurality of assembled sectors made of precast concrete, adjacent sectors of this segment being assembled by clamping devices and the segment comprising at the interface of adjacent sectors shear keys cast with the sectors.

The present invention relates to towers for holding wind turbines, and more particularly but not exclusively to onshore wind turbine towers.

It has been proposed to make wind turbine towers in precast concrete elements, that are transported to the site where the tower is to be elevated, and assembled there.

So far, these elements are cumbersome, which necessitates special transportation vehicles.

U.S. Pat. No. 8,505,244 discloses a tower made of assembled annular segments, each made of a plurality of sectors.

The sectors are assembled by mortar or via flanges having openings through which metallic bars pass.

The openings are larger than the bars and the play, together with manufacturing tolerances, may result in difficulties for assembling the sectors with the required precision.

U.S. Pat. No. 8,950,149 discloses a polygonal concrete structure such as a wind turbine tower, made of precast concrete elements. The joint between the precast concrete elements comprises two semi-circular vertical groves extending over all the height of the elements and forming together an injection channel in which grout can be introduced. Corresponding recesses in the form of horizontal grooves and tongues on opposite edges of the elements are provided to accommodate loads. Each lateral end face of an element comprises two parallel surfaces that are deprived of reliefs and that open out on the intrados and the extrados, respectively. These surfaces are connected by an intermediate surface that is provided with the injection channel and the above-mentioned tongue and groove arrangements. The intermediate surface also carries a seal that extends over the entire height of the elements. The need for grout at the interface renders the assembling of the elements relatively complex and time consuming.

KR101677673 discloses a structure made of precast concrete elements with a joint provided with shear keys and corresponding recesses. These recesses are centered at mid-thickness of the element and are radially spaced from the intrados and the extrados of the elements. When the last precast element is introduced to complete a section of the structure, there must exist a significant play in the structure to accommodate the element, which requires to act again on the assembly of other the elements afterwards and to move them. The elements are assembled via metallic strips bolted to the intrados of the elements, which makes the structure relatively complex to make and assemble.

CN207297238U discloses a tower made of precast concrete elements. Adjacent elements comprise some vertical guiding pins that serve to position the elements before a grout is injected at the interface between the elements.

There exists a need for a wind turbine tower that can be easily manufactured and assembled, and that overcomes at least some of the drawbacks of the prior art, relating to transportation of the elements inter alia.

Exemplary embodiments of the invention relate to a wind turbine tower comprising a plurality of annular segments axially aligned with each other, at least one of the annular segments comprising a plurality of assembled sectors made of precast concrete, adjacent sectors of this segment being assembled by clamping devices, preferably bolting systems, and the segment comprising at the interface of adjacent sectors shear keys cast with the sectors.

The shear keys contribute to the transmission of vertical forces between the sectors.

Thanks to the invention, the tower can be made of a relatively high number of sectors, easy to manufacture and assemble, with the required mechanical resistance and precision of assembly. The sectors can be made of a size easy to transport with conventional vehicles, and the cost of transportation is reduced. Each sector preferably has a height and a width less than 4.5 m (height) and 8 m (width) respectively.

The tower may comprise more than half of its segments that are made with such sectors provided with shear keys. All sectors of the tower may comprise shear keys.

The total height of the tower (without the wind turbine) may exceed 100 m.

The external diameter of the tower may range from 4 m to 15 m.

The number of segments of the tower may range from 20 to 150.

The number of sectors per segment may range from 2 to 10.

The tower may comprise a first section made of segments having a given number n₁ of sectors per segment and a second portion made of segments having a different number n₂ of sectors per segment. These two sections may be made of segments having different external diameters. The smaller diameter segments may have a smaller number of sectors than the larger diameter segments.

Most segments may be of cylindrical shape, but some segments may be of frustoconical shape. These frustoconical segments may be used at the transition from two sections of the tower made of segments having different diameters.

The recesses for accommodating the shear keys preferably open out onto the intrados of the sectors. This makes the assembly of the sectors easy, as the sectors only need to be inserted with a radial movement between sectors already in place. These recessed may be closed at the other radial end and as such do not open onto the extrados of the sectors. This helps give the tower a smooth external surface. The number of shear keys on a same lateral end face of a sector may range from 1 to 10. Preferably, the lateral end face has three shear keys, two of them being close to a respective axial end face of the sector, and the third one being substantially at mid-height.

Each shear key may have a greatest dimension less than 400 cm. The thickness of the shear key, i.e. the maximum distance by which it protrudes out of the corresponding lateral end face of the sector, may range from 1 to 20 cm.

Each lateral end face or axial end face of a sector may be planar, except for the corresponding shear keys or recesses used for interlocking with an adjacent sector and/or for receiving centering pins or components of a bolting system.

Preferably, the lateral end face of a sector adjacent the recess and the outer circumference is radially oriented.

To allow for the radial insertion of the last sector, the angle b between the lateral end face and the most radially outer end face of a shear key is not greater than 360/2n, where n is the number of sectors that are assembled to form a segment. Preferably, these faces and are substantially parallel to each other.

The portion of the lateral end face of a sector that extends radially between a recess and the outer circumference (extrados) is preferably of a shape that is substantially complementary to the shape of the portion of the lateral end face of the adjacent sector that extends radially between the shear key and the outer circumference.

The lateral end face of a sector adjacent a shear key may be provided with an axial grove.

The shear keys are preferably oriented substantially perpendicularly to the tangent to the extrados in the vicinity of the interface between the sectors.

Each sector may comprise axial ribs protruding inwardly adjacent the end faces of the sector, the ribs preferably having a triangular cross section. These ribs help concrete to flow and promote evacuation of bubbles that may otherwise remain at the lateral end faces of the segments during the casting operation. These ribs face upwards when the segment is cast. The clamping devices may comprise bolts that extend through a corresponding rib, preferably at its base. The bolts preferably extend each in a horizontal plane.

The sectors preferably comprise sockets for receiving bolts of the clamping devices, the sockets being advantageously integrated into the sector during casting thereof.

Each sector may comprise at least one axial bore extending from each axial end of the sector along at least part of the height of the sector. At least one of the bores preferably opens out in a recess formed on the internal surface of the sector. These bores serve to introduce bars extending between two consecutive segments and help fastening the segments one to another.

Some of the sectors of at least one segment preferably comprise holes opening out on the external surface (extrados) of the segment, for hoisting a section of the tower and/or for anchoring of a self-elevating machine used for erecting the tower.

Preferably, centering pins are engaged between sectors of two adjacent segments. These centering pins are preferably biconical. These pins help to position precisely the segments on top of each other and may also contribute to transmit horizontal shear forces between the segments.

The invention also relates to a method for the production of sectors of a tower, preferably a tower as defined above, comprising transferring at least one mold between different workstations, including:
A workstation where the mold is open,
a workstation where a cast sector is extracted from the mold,
a workstation where the mold is cleaned,
a workstation where rebar is positioned in the mold,
a workstation where the mold is closed,
a workstation where concrete is injected in the mold, and
a workstation where concrete is let set in the mold.

Such a method is different from the prior art where the formworks used for casting the tower elements are static. The method according to the invention offers a higher productivity, which makes up for the larger number of sectors to make due to their smaller dimensions.

The method preferably involves a plurality of molds that are moved along the different workstations, preferably in a closed loop.

One or more than one mold can be processed at each workstation.

Preferably, each mold is machined so as to provide manufacture tolerances not greater than 5 mm, better 3 mm, even better 1 mm or 0.5 mm, on faces of a sector intended to contact other sectors. A high precision of manufacture of the sectors results in an easier assembling of the sectors and the segments, and it allows to have dry joints between the sectors and the segments.

The mold preferably has a surface that is oriented upwards and that is configured for casting the extrados of the sector, so that the extrados of the sector faces downward when the sector is cast.

The number of sectors made every day by such a method in a same production line may exceed 200.

The invention also relates to a method for constructing a tower, preferably a tower as defined above, comprising transporting sectors from a plant where the sectors are made to a construction site for the tower, the transportation being performed with low bed or regular trucks and more than one sector per truck, assembling the sectors to form the segments, and then assembling the segments.

The sectors of a segment are advantageously assembled on a rotating platform.

Each sector may be carried during assembly by an end of a manipulating arm of a wheeled truck, without hoisting. However, hoisting is also possible.

The sectors may have dry joints, i.e. no grout or cement is being injected at the interface of two assembled sectors of one segment.

A coating of a polymeric binder (e.g. an epoxy resin) may be applied on the shear keys before the sectors are assembled, to lubricate the interface and improve transmission of forces.

The rotating platform preferably comprises tracks for transfer of a complete segment out of the platform, jacks for lifting the segment to position thereunder transportation members, and at least one arm to hold a first sector on the platform while awaiting other sectors to be assembled thereon. The platform may be rotated by 360/n, where n is the number of sectors in the segment, after each sector is assembled, until the before last one. The transportation members may be rollers and/or sliding pads made of PTFE or similar low friction material.

The invention also relates to a sector made in accordance with the invention and to a plant for performing the method as defined above, as well as to a rotatable platform for assembling the sectors.

This platform preferably comprises a fixed base and a rotatable table. The latter may comprise a circular track, and at least one arm extending radially for positioning a sector before its assembly to other sectors placed subsequently on the table. The table may comprise parallel beams that form a track for discharging the assembled segment from the table. This track may be aligned by rotating the platform with an external track serving to transport the segments to a hoisting or other equipment used for assembling the segments.

Further features and advantages of the invention will become apparent on reading the detailed description that follows, and in view of the accompanying drawing, in which:

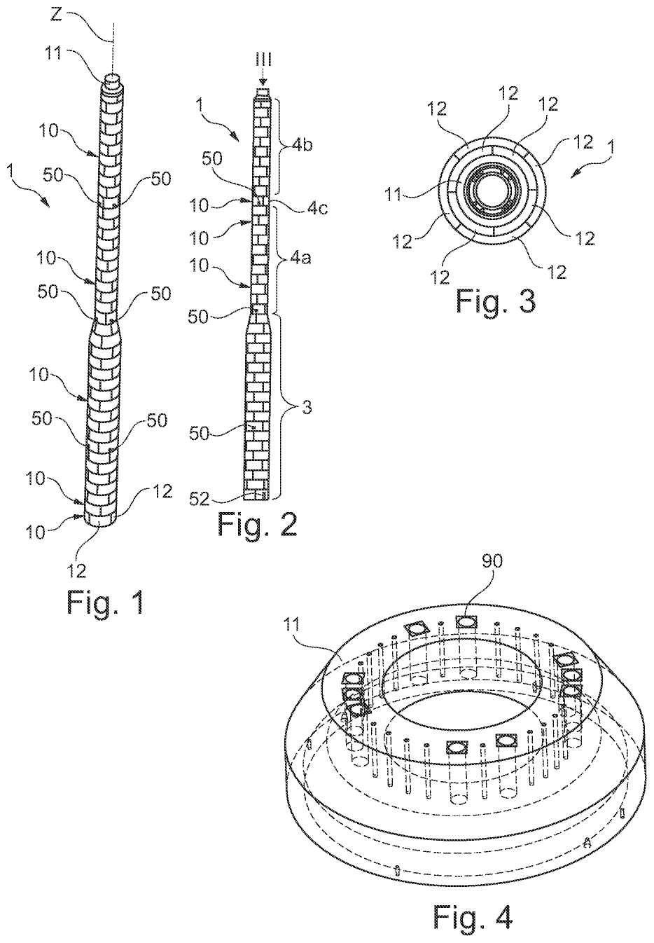

FIG. 1 is a perspective view of an example of wind turbine tower made in accordance with the invention,

FIG. 2 shows the tower of FIG. 1 in elevation,

FIG. 3 is a top view of the tower according to arrow III of FIG. 2,

FIG. 4 shows the top end element of the tower, for fixing thereto the wind turbine,

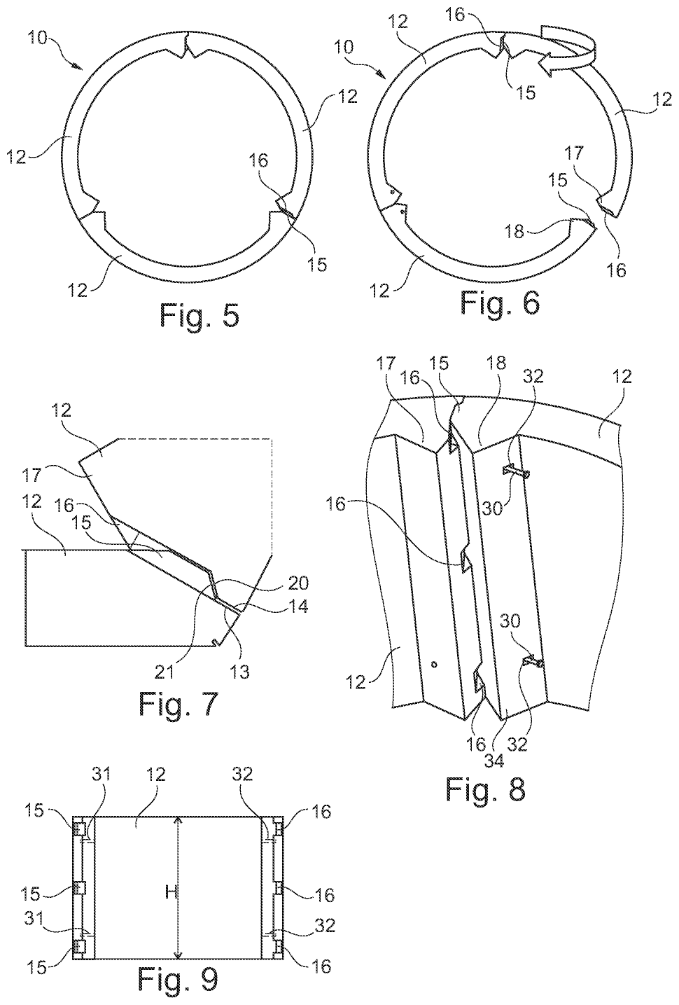

FIG. 5 shows a three sectors segment,

FIG. 6 illustrates the locking of one sector with respect to the other sectors,

FIG. 7 shows a detail of the interface between sectors,

FIG. 8 shows two adjacent sectors before bolting,

FIG. 9 shows one sector in elevation,

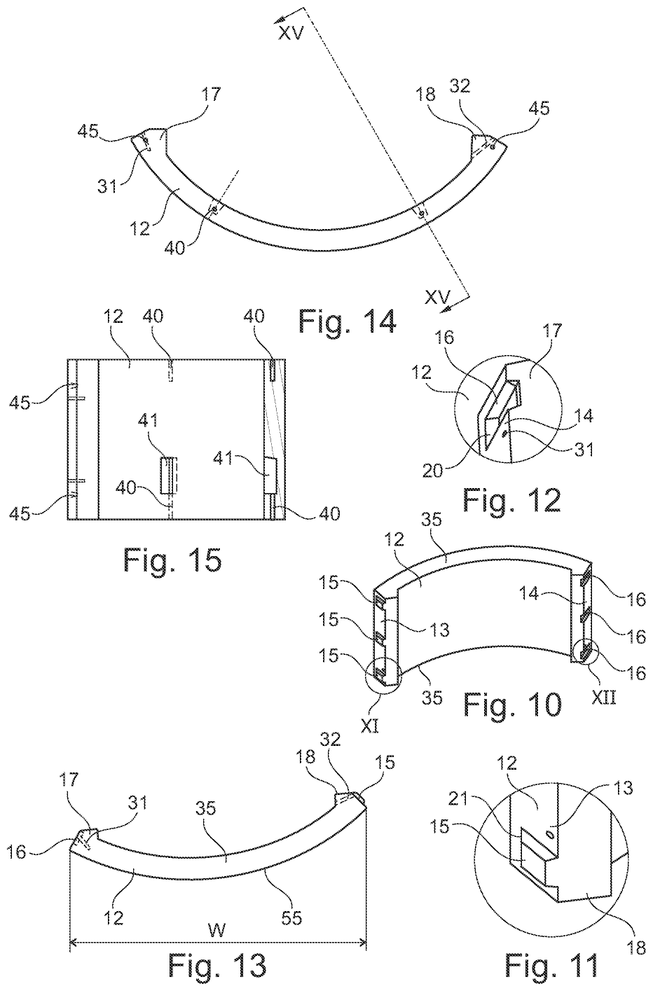

FIG. 10 shows one sector in perspective,

FIG. 11 shows detail XI of FIG. 10,

FIG. 12 shows detail XII of FIG. 10,

FIG. 13 shows the sector of FIG. 9 in its casting configuration,

FIG. 14 shows a variant of a sector,

FIG. 15 is a section across XV-XV of FIG. 14,

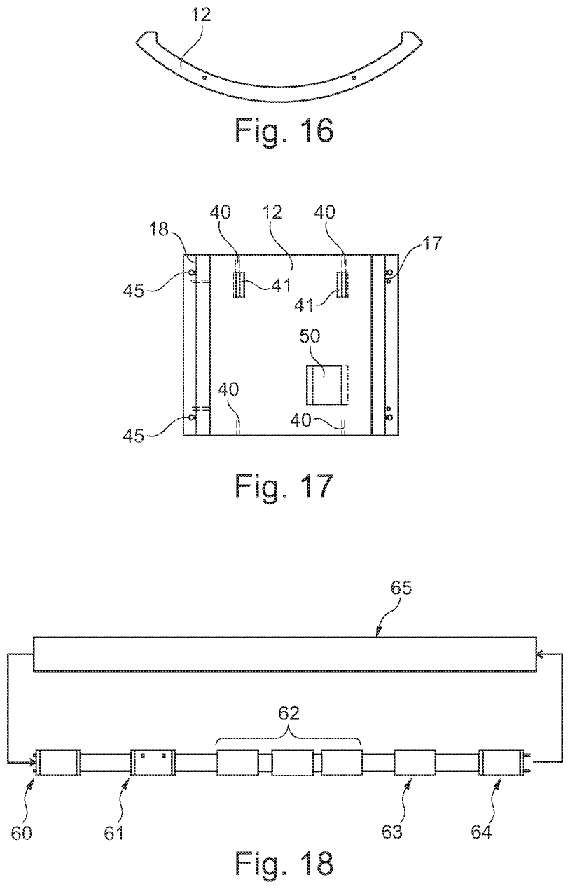

FIG. 16 shows the sector of FIG. 14 in its casting configuration,

FIG. 17 shows another variant of a sector,

FIG. 18 is a schematic view of a plant for producing the sectors,

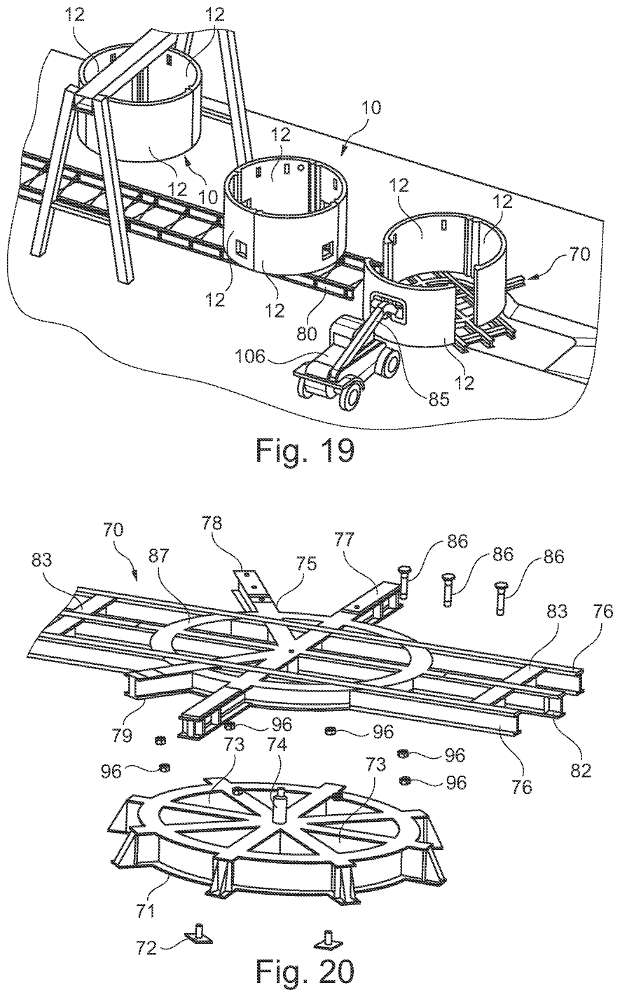

FIG. 19 is a schematic view of a platform for assembling the sectors,

FIG. 20 is a perspective view of the platform,

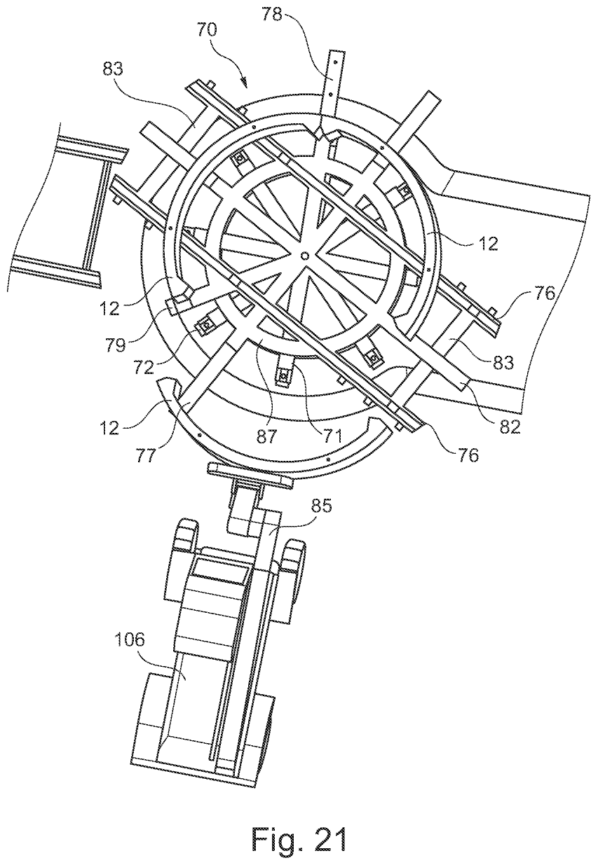

FIG. 21 is a top view of the platform,

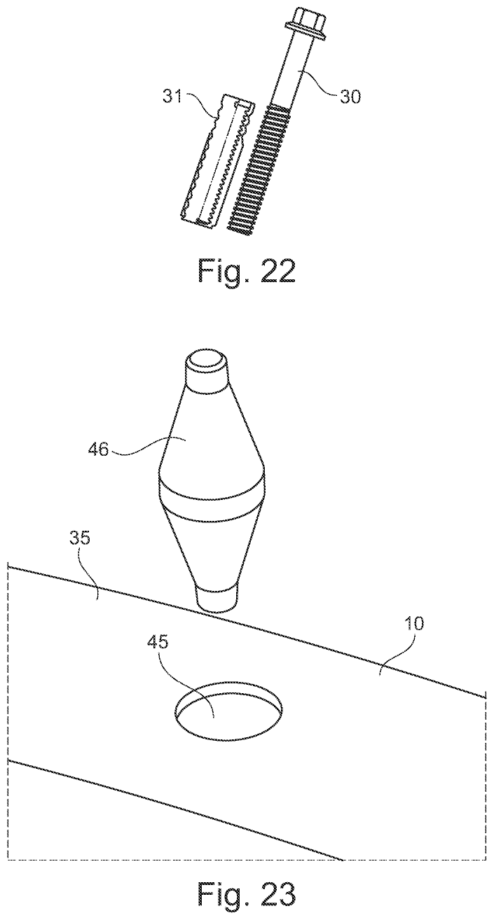

FIG. 22 shows in isolation a clamping device.

FIG. 23 shows a centering pin and a corresponding recess in axial end face of a sector,

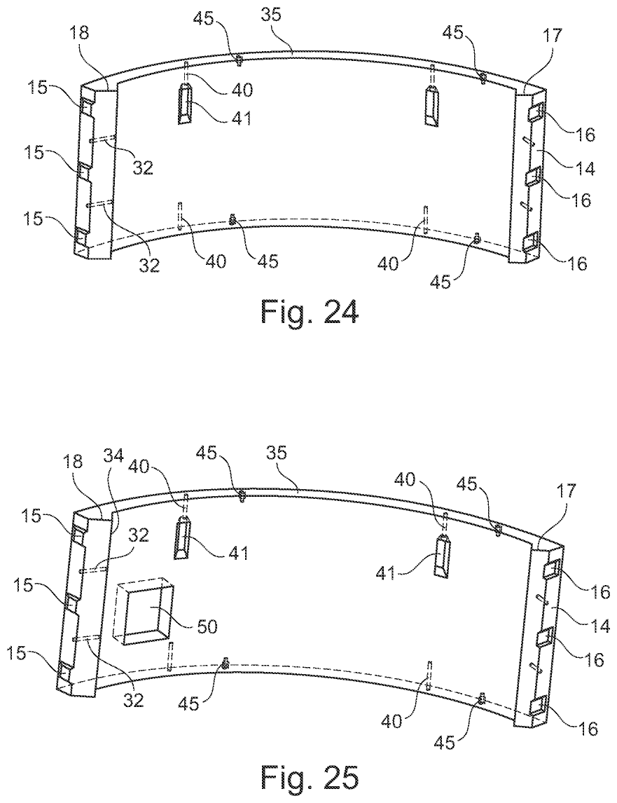

FIG. 24 is a perspective view showing in transparency internal recesses of an example of a sector,

FIG. 25 is a view similar to FIG. 24 of another example of a sector,

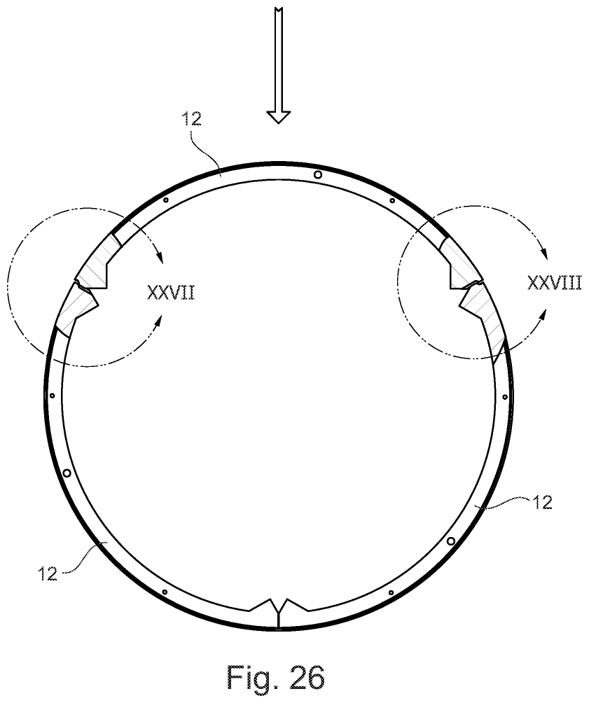

FIG. 26 illustrates the connection of sectors by radial displacement,

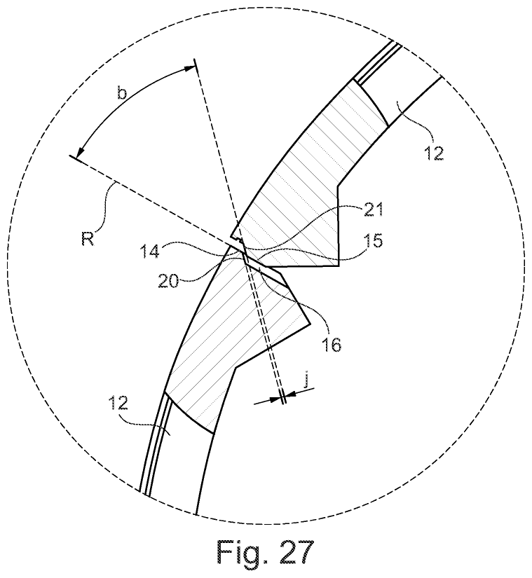

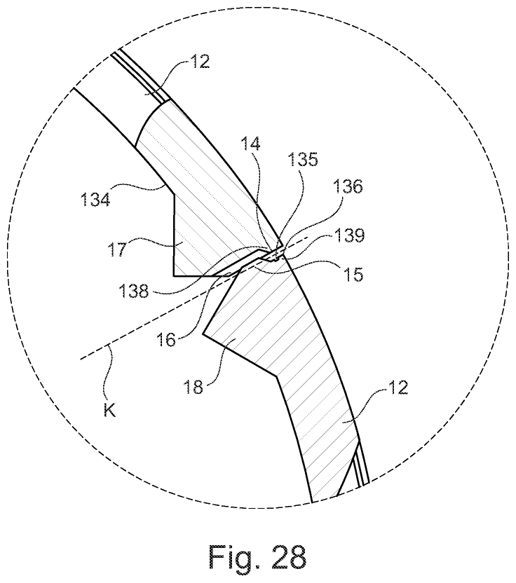

FIG. 27 shows the detail XXVII of FIG. 26, and

FIG. 28 shows the detail XXVIII of FIG. 26.

### DETAILED DESCRIPTION

FIGS. 1 and 2 shows a wind turbine tower 1 made in accordance with the present invention.

The tower 1 comprises a plurality of segments 10 that are assembled vertically along the longitudinal axis Z of the tower.

The wind turbine (not shown) is affixed on top the tower 1 thanks to an end element 11 shown in isolation in FIG. 4.

Each segment 10 is ring shaped and composed of sectors 12, that are preferably arc-shaped, as shown.

The number of sectors 12 per segment 10 may vary according to the position of the segment along the tower 1.

In the illustrated embodiment, the tower 1 comprises a lower portion 3 starting from the bottom of the tower, made of four sector segments, then a higher portion composed of two sections 4a and 4b made of three sector segments, the two sections 4a and 4b being separated at 4c by an intermediate four sector segment 10.

The lower section 3 may be constituted mainly of cylindrical segments 10 and may comprise as shown a top portion made of at least one frustoconical segment, to reduce the external diameter of the tower to that of the section 4a.

FIGS. 5 to 13 show one of the three sector segments 10.

Each sector 12 is made of reinforced concrete and has lateral end faces 13 and 14 provided with shear keys 15 and corresponding recesses 16, respectively. These lateral end faces are oriented vertically in the tower.

Each sector 12 comprises bosses 17 and 18 that protrude inwardly adjacent the lateral end faces 14 and 13 respectively.

The recesses 16 open out onto the intrados of the sectors, as can be seen in FIG. 7, and extend along part of the adjacent boss 17.

As shown in FIG. 8, there are preferably three shear keys 15 per sector 12.

The bottom 20 of each recess 16 may be of a shape substantially complementary to that of the most radially outward end 21 of the shear key 15, as shown in FIG. 7.

The sectors 12 are preferably assembled by clamping devices such as bolting systems that comprise as shown in FIG. 22 bolts 30 and associated sockets 31, internally threaded and into which the bolts can be screwed.

The bolts 30 extend through holes 32 of the sectors 12 while the sockets 31 are integrated into the sectors 12 during casting thereof.

The holes 32 open out onto a rear face 34 of the boss 18, as shown in FIG. 8.

There may be two bolting systems 30, 31 per interface between two adjacent sectors 12 of a same segment 10, as shown in FIG. 8. The bolts 30 are oriented substantially horizontally in the tower 1.

The shear keys 15 and recesses 16 help position one sector relative to another one to complete a segment, as shown in FIG. 6, and will be detailed further below.

The sectors 12 may be provided with additional features, that are now described in relation to FIGS. 14 to 17, 24 and 25.

The shear keys 15 and corresponding recesses 16 of the sectors are not shown in FIGS. 14 to 17, to illustrate that not all the sectors of the tower need to exhibit these features.

FIGS. 24 and 25 show examples of sectors 12 that encompass both shear keys as described with reference to FIGS. 5 to 13 and the additional features.

At least some of the sectors 12 may comprise axial bores 40 that open out on axial end faces 35 of the sectors 12. These axial end faces are oriented horizontally in the tower. Some recesses 41 may be formed on the intrados of the sectors 12 to provide access to an end of at least some of the bores 40, for tightening the bars.

These bores 40 serve to receive bars used to assemble adjacent segments.

The end faces of the sectors 12 may be provided with recesses 45 for receiving biconical centering pins 46 as shown in FIG. 23. These recesses 45 may be present on lateral end faces as well as on axial end faces.

Some sectors 12 may comprise windows 50, as shown in FIG. 17 and FIG. 25.

These windows 50 may be used for insertion of gripping arms of a machine known per se, serving to erect the tower.

In the example shown in FIGS. 1 and 2, the tower 1 also comprises at its base a door opening 52, giving access to the inside of the tower 1.

The sectors 12 are of relatively small dimensions and are preferably made in a plant in molds that are moved between different workstations.

The width W of a sector 12 is preferably less than 8 m and its height H is preferably less than 4.5 m.

Each mold serving to cast a sector is preferably machined with a relatively high precision, so that the manufacturing tolerances on at least some surfaces of the sector are within a relatively low value, which is less than 5 mm, better 2 mm, and even better 1 mm or 0.5 mm.

In particular, the manufacturing tolerances of the lateral end faces 13 and 14, and of the axial end faces 35, are better than this value.

Each sector 12 is cast is its corresponding mold with its extrados 55 facing downwards, as illustrated in FIG. 13 or 16. The surface of the mold serving to mold the extrados thus constitutes the bottom of the mold. This allows to fill the mold by gravity pouring of the concrete in the mold.

A plurality of molds is used simultaneously in a production line, and the molds are displaced by any appropriate transportation means such as a carrousel from one workstation to another.

The molds are preferably transported in a closed loop between the different workstations.

The production line enables the production in continuous manner of the sectors.

The production line comprises a workstation 60, as illustrated in FIG. 18, where the mold is open.

The mold once in its open state is transported to the next workstation 61, where the cast sector 12 is extracted from the mold.

The empty mold then reaches a workstation 62 where the mold is cleaned, rebar is installed in the mold, and the mold is closed.

The closed mold then is transported to the next workstation 63 where it is filled with concrete.

The mold can then be transported to a workstation 64 where it is cleaned externally, and to a workstation 65 constituting a drying stove or tunnel, where the setting of the concrete will take place.

The molds leaving the workstation 65 then reaches the workstation 60, and the process is repeated.

The sectors 12 leaving the manufacture line are transported to the assembly site, where the tower will be erected.

Due to the size of the sectors, a plurality of sectors can be transported simultaneously on a conventional flat-bed truck.

At the tower assembly site, the sectors 12 are assembled to form the segments 10.

According to one aspect of the invention, a rotatable platform 70 is used to facilitate the assembling of the sectors, as illustrated in FIGS. 19 to 21.

The platform 70 comprises a fixed base 71, that is provided with adjustable feet 72. The base can receive ballast 73 to help stabilize it.

The base 71 comprises a vertical central shaft 74 on which an assembly table 75 is articulated.

Rolling bearings 96 are interposed between the base 71 and table 75.

The table 75 comprises a set of two parallel beams 76 which form a track that can be aligned with a track 80 external to the platform 70, allowing an assembled segment to leave the platform 70 by rolling on the beams 76 and on the track 80, without the need for hoisting equipment.

The beams 76 are connected by a circular track 87, on which the rolling bearings 96 bear.

The table 75 comprises a transverse beam 77 that extends beyond the circular track 87, and two oblique arms 78 and 79 that extend radially from the center of the table 75 beyond the circular track 87.

The beam 77 and arms 78 and 79 join at the center of the table 75.

A median beam 82 extends parallel to the beams 76, and transverse beams 83 connect the beams 76 and 82 together.

The arm 78 is longer than the arm 79, as can be seen in FIG. 21.

The sectors 12 are manipulated by an articulated arm 85 of a wheeled vehicle 106 when they are installed on the table 75, as shown in FIGS. 19 and 21. The sectors may be introduced from a same side of the platform, and the table is rotated for the introduction of the next sector. This renders the assembling convenient.

A coating of a polymeric binder may be applied on the shear keys before the sectors 12 are assembled, to lubricate the interface and improve transmission of forces. There is no need to introduce grout at the interface between the sectors.

When all sectors 12 but one are assembled, the last sector 12 can be introduced by a radial movement, as illustrated in FIG. 21 and in FIGS. 26 to 28.

To allow for the radial insertion of the last sector 12, without having to move the sectors 12 already in place, the angle b between a radius R along which the lateral end face 14 is aligned adjacent the recess 16 and the end face 21 of the shear key 15 is not greater than 360/2n, where n is the number of sectors 12 that are assembled to form a segment 10 (n is equal to 3 in FIG. 26). This results in a positive play j at the interface between the bottom face 20 and end face 21, which facilitates the radial insertion of the last sector during completion of the segment, as shown in FIG. 27. One can see in FIG. 28 that faces 20 and 21 are substantially parallel to each other and that the recesses 16 open out only onto the intrados 134 of the corresponding sector 12. The portion 138 of the lateral end face that extends radially between a recess 16 and the outer circumference is of a shape that is substantially complementary to the shape of the portion 139 of the lateral end face of the adjacent sector that extends radially between the corresponding shear key 15 and the outer circumference. One can also see that the lateral end face 136 of a sector adjacent a shear key 15 may be provided with an axial grove 135. This grove accommodates an elastomeric seal (not shown) being circular, rectangular or with a lip in cross section, that provides some sealing at the interface of the sectors. The seal may be in Neoprene or other materials. One can see from FIG. 28 inter alia that the shear keys 15 that extend along the lateral end face of the corresponding sector are oriented substantially radially in a direction K, giving them an orientation that is substantially perpendicular to the tangent to the extrados in the vicinity of the interface between the sectors.

Sectors 12 already present on the table 75 can be maintained by bars (not shown) installed on the beam 77 and arms 78 and 79, before being bolted together using the bolting systems 30, 31.

The platform 70 comprises lifting jacks 86 for lifting the sectors 12 at some height above the table 75, to allow for placement below the segment 10 of rolling members.

The segments 10 once formed are assembled to form the tower 1.

During the assembling of the segments 10, bars (not shown) may be introduced in the axial bores 40 opening out on the axial end faces 35 of the sectors 12.

Even if the axial end faces 35 may comprise conical recesses 45 into which centering pins 46 are inserted, as mentioned above, the tower is preferably constructed in such a manner that the nominal mechanical loads are withstand without the need of the additional resistance brought by the presence of these centering pins 46.

The segments 10 may be assembled by dry joint, with no concrete or resin binder inserted between two consecutive segments 10.

Preferably, as can be seen in FIGS. 1 and 2, the segments 10 are angularly offset so that the vertical joint between the sectors of one segment is positioned substantially at the middle of the sectors of the adjacent segments 10.

Thanks to the precision with which the sectors 12 are manufactured, there is no significant misalignment of the axial end faces 35 of the sectors 12 of a same segment 10 (i.e. the horizontal joint of a segment).

Post-tensioning tendons may be used to prestress the segments 10.

Some tendons may be used during the erection of the tower and anchored in intermediate segments.

Some other tendons may be tensioned only after the erection of the tower is completed.

These tendons may be anchored at one end in the top ring element 11 thanks to anchors 90, and at the other end in the foundation of the tower.

These tendons are preferably made of cables that extend within the internal space of the tower 1, outside the concrete wall of the sectors 12.

The invention is not limited to the disclosed embodiment and various modifications can be brought to the latter without departing from the scope of the invention.

For example, the tensioning tendons may extend through passages internal to the sectors.

The segments may be of a ring shape other than circular, for example polygonal, in particular hexagonal.

1. A wind turbine tower comprising a plurality of annular segments axially aligned with each other, at least one of the annular segments comprising a plurality of assembled sectors made of precast concrete, adjacent sectors of this segment being assembled by clamping devices and the segment comprising at the interface of adjacent sectors shear keys cast with the sectors, the sectors comprising recesses for accommodating the shear keys, these recesses opening out onto the intrados of the sectors.

2. The tower of claim 1, wherein the lateral end face of a sector adjacent a recess and the outer circumference is radially oriented.

3. The tower of claim 2, wherein the angle b between the lateral end face and the most radially outer end face of a shear key is not greater than 360/2n, where n is the number of sectors that are assembled to form a segment.

4. The tower of claim 2, wherein the portion of the lateral end face of a sector that extends radially between a recess and the outer circumference is of a shape that is substantially complementary to the shape of the portion of the lateral end face of the adjacent sector that extends radially between the corresponding shear key and the outer circumference.

5. The tower of claim 1, wherein the shear keys are oriented substantially perpendicularly to the tangent to the extrados in the vicinity of the interface between the sectors.

6. The tower of claim 1, wherein each sector comprises axial ribs protruding inwardly adjacent the lateral end faces of the sector.

7. The tower of claim 6, wherein the clamping devices bolts that extend through a corresponding rib.

8. The tower of claim 1, wherein the sectors sockets for receiving bolts of the clamping devices, the sockets being integrated into the sectors during casting thereof.

9. The tower according to claim 1, wherein each sector comprise at least one axial bore extending from each axial end of the sector along at least part of the height of the sector, at least one of the bores.

10. The tower of claim 1, wherein at least some of the sectors of at least one segment comprise windows opening out on the extrados of the segment, for hoisting the segment or anchoring of a machine used for elevating the tower.

11. The tower of claim 1, further comprising biconical centering pins engaged between the sectors of two adjacent segments.

12. The tower of claim 1, wherein each sector having a height and a width less than 4.5 m and 8 m respectively each.

13. The tower of claim 1, wherein the sectors being assembled with dry joints at their interface to form the segments.

14. The tower of claim 1, wherein the segments are assembled with dry joints at their interface.

15. A method for the production of sectors of a tower as defined in claim 1, comprising transferring a mold between different workstations, including:
a workstation where the mold is open,
a workstation where a cast sector is extracted from the mold,
a workstation where the mold is cleaned,
a workstation where rebar is positioned in the mold,
a workstation where the mold is closed,
a workstation where concrete is injected in the mold,
a workstation where concrete is let set in the mold.

16. The method of claim 15, wherein the mold is machined to provide manufacturing tolerance not greater than 5 mm on faces of a sector intended to contact other sectors.

17. The method of claim 15, wherein the mold has a surface configured for casting the extrados that is oriented so that the extrados of the sector faces downward when the sector is cast.

18. A method for constructing a tower as defined in claim 1, comprising transporting the sectors from a plant where the sectors are made to a construction site for the tower, the transportation being performed with regular or low bed trucks and more than one sector per truck, assembling the sectors to form the segments, and then assembling the segments.

19. The method of claim 18, wherein the sectors of a segment being assembled on a rotating platform, each sector being carried during assembly by an end of a manipulating arm of a wheeled vehicle, without hoisting.

20. The method of claim 19, wherein the rotating platform comprising a track for transfer of a completed segment out of the platform, jacks for lifting the segment to position thereunder transportation members, and at least one arm to hold a first sector on the platform while awaiting other sectors to be assembled thereon.
